(19) United States
(12) Patent Application Publication
(10) Pub. No.: US 2022/0048592 A1
(43) Pub. Date: Feb. 17, 2022

(54) Crank assembly particularly suited for bicycles

(71) Applicant: Charles A. Shaw, Bakersville, CA (US)

(72) Inventor: Charles A. Shaw, Bakersville, CA (US)

(21) Appl. No.: 16/873,915

(22) Filed: Aug. 14, 2020

(51) Int. Cl. B62M 1/36; B62M 3/00

(52) U.S. Cl. CPC B62M 1/36; B62M 3/00

(57) ABSTRACT

A bicycle crank assembly is provided having a sprocket flange and a pedal crank arm, the sprocket flange being coaxially affixed to a bicycle crank shaft, the first end of the pedal crank arm being coaxially mounted about a laterally projecting generally cylindrical shaft member of the sprocket flange, a pedal bolt being affixed proximate a distal end of the pedal crank arm, and the pedal crank arm being affixed proximate the perimeter of the sprocket flange generally opposite the pedal bolt with a 145 degree offset about the axis of rotation of the bicycle crank shaft to increase the distance from the drive bolt to the pedal and to increase the leverage and power imparted to the bicycle crank assembly. A sprocket is coaxially affixed to the sprocket flange. A second pedal-powered crank assembly is coaxially affixed to the opposite end of the bicycle crank shaft, with a 180 degree offset about the axis of rotation of the bicycle crank shaft from the first pedal-powered crank assembly to provide continuous, uninterrupted torque to the bicycle crank shaft through a 360-degree rotation of the pedal-powered crank assembly.

### BACKGROUND OF THE INVENTION

### 1. Field of the Invention

The invention generally relates to a pedal-powered crank assembly. More specifically, the invention relates to a pedal-powered crank assembly particularly suited for bicycles, having a first sprocket flange, and a first pedal crank arm. The first sprocket flange is coaxially affixed to the first end of a conventional bicycle crank shaft, the first end of the first pedal crank arm is coaxially mounted about a first laterally projecting generally cylindrical shaft member of the first sprocket flange, a first conventional pedal bolt is affixed proximate the distal end of the first pedal crank arm, and the first pedal crank arm is affixed proximate the perimeter of the first sprocket flange generally opposite the first conventional pedal bolt with a 145 degree offset about the axis of rotation of the bicycle crank shaft to increase the distance from the drive bolt to the pedal and to increase the leverage and power imparted to the pedal-powered crank assembly. A conventional sprocket is coaxially affixed to the sprocket flange. Preferably, a second pedal-powered crank assembly constructed according to the principles of the first pedal-powered crank assembly is coaxially affixed to the opposite end of the bicycle crank shaft, with the first pedal-powered crank assembly and second pedal-powered crank assembly 180 degrees opposed to each other to provide continuous, uninterrupted torque to the bicycle crank shaft through a 360-degree rotation of the first bicycle crank assembly and second pedal-powered crank assembly.

### 2. The Prior Art

There are a variety of prior art devices for use with conventional pedal-powered crank assembly crank assemblies include a pair of foot pedals carried at the ends of a pair of pedal crank arms and rotatable about a horizontal axis of the first crank shaft for rotating a sprocket coupled by a chain to the rear wheel of the bicycle. One of the drawbacks in such a system is that it does not best exploit the power which a person can apply to the foot pedals. Thus, in conventional bicycle the foot pedals are rigidly mounted 180 degrees apart, and the operator applies maximum power in the vertical downward strokes of the foot pedals. Minimum power is applied during the generally horizontal movements of the foot pedals, namely at the beginning and ends of the downwards strokes when the foot pedals are in or near their dead-center positions, i.e., in alignment with the bottom bracket axle. Since the two foot pedals are rigidly mounted 180 degrees apart, both reach this point of minimum power at the same time, thereby increasing the effort required by the operator to propel the bicycle. There is no satisfactory known solution to these problems provided in the prior art.

### SUMMARY OF THE INVENTION

It is therefore an objective of this invention to provide a pedal-powered crank assembly producing a more efficient transmission of power from a pair of pedal crank arms to a sprocket.

Another object of the invention is to provide a pedal-powered crank assembly that optimizes the leverage and power to the imparted by the user to a sprocket.

Still another object of the invention is to provide a pair of pedal-powered crank assemblies that provides, in combination, continuous, uninterrupted torque to the bicycle crank shaft through a 360-degree rotation of the pedal-powered crank assemblies.

Still another object of the invention is to provide a pedal-powered crank assembly that is easy to manufacture and inexpensive.

Yet another object of the invention is to provide a pedal-powered crank assembly that may be used on a variety of pedal-driven devices and with a variety of conventional sprockets and conventional crank shafts.

These together with other objects of the present invention, along with the various features of novelty which characterize the present invention, are pointed out with particularity in the claims annexed to and forming a part of this disclosure. For a better understanding of the present invention, its operating advantages and the specific objects attained by its uses, reference should be had to the accompanying drawings and descriptive matter in which there is illustrated a preferred embodiment of the present invention and alternative embodiments.

In a preferred embodiment, a pedal-powered crank assembly is provided. The pedal-powered crank assembly has a first sprocket flange and a first pedal crank arm. The first sprocket flange is coaxially affixed to a conventional bicycle crank shaft, the first end of the first pedal crank arm is coaxially mounted about a first laterally projecting generally cylindrical shaft member of the first sprocket flange, a conventional pedal bolt is affixed proximate a distal end of the pedal crank arm, and the pedal crank arm is affixed proximate the perimeter of the sprocket flange generally opposite the conventional pedal bolt with a 145 degree offset about the axis of rotation of the bicycle crank shaft to increase the distance from the drive bolt to the pedal and to increase the leverage and power imparted to the pedal-powered crank assembly. A conventional sprocket is coaxially affixed to the sprocket flange. A second pedal-powered crank assembly constructed according to the principles of the first pedal-powered crank assembly is coaxially affixed to the opposite end of the bicycle crank shaft, with the first pedal-powered crank assembly and second pedal-powered crank assembly 180 degrees opposed to each other to provide continuous, uninterrupted torque to the bicycle crank shaft through a 360-degree rotation of the first bicycle crank assembly and second pedal-powered crank assembly.

There has thus been outlined, rather broadly, the more important features of the invention in order that the detailed description thereof that follows may be better understood, and in order that the present contribution to the art may be better appreciated. There are, of course, additional features of the invention that will be described hereinafter and that will form the subject matter of the invention.

Before explaining the preferred embodiment and alternative embodiments of the present invention in detail, it is to be understood that the present invention is not limited in its application to the details of construction, to the arrangements of the components set forth in the following description or illustrated in the drawings, or to the methods described therein. The present invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the present invention in any way.

### BRIEF DESCRIPTION OF THE DRAWINGS

FIG. 1 is a perspective view of the pedal-powered crank assembly of a preferred embodiment of the invention employed with a conventional bicycle crank shaft and conventional pedal bolt.

FIG. 2 is a front elevational view of a pedal-powered crank assembly of a preferred embodiment of the invention.

FIG. 3 is a rear elevational view of a pedal-powered crank assembly of a preferred embodiment of the invention.

FIG. 4 is a left side elevational view of a pedal-powered crank assembly of a preferred embodiment of the invention.

FIG. 5 is a right side elevational view of a pedal-powered crank assembly of a preferred embodiment of the invention.

FIG. 6 is a front elevational view of a sprocket flange of a preferred embodiment of the invention.

FIG. 7 is a rear elevational view of a sprocket flange of a preferred embodiment of the invention.

FIG. 8 is a left side elevational view of a sprocket flange of a preferred embodiment of the invention.

FIG. 9 is a right side elevational view of a sprocket flange of a preferred embodiment of the invention.

FIG. 10 is a front elevational view of a pedal crank arm of a preferred embodiment of the invention.

FIG. 11 is a rear elevational view of a pedal crank arm of a preferred embodiment of the invention.

FIG. 12 is a left side elevational view of a pedal crank arm of a preferred embodiment of the invention.

FIG. 13 is a right side elevational view of a pedal crank arm of a preferred embodiment of the invention.

FIG. 14 is a right side elevational view of a second step washer of a preferred embodiment of the invention.

FIG. 15 is a front elevational view of a second step washer of a preferred embodiment of the invention.

FIG. 16 is a rear elevational view of a second step washer of a preferred embodiment of the invention.

FIG. 17 is a right side elevational view of a first threaded button head drive bolt of a preferred embodiment of the invention.

FIG. 18 is a front elevational view of a first threaded button head drive bolt of a preferred embodiment of the invention.

FIG. 19 is a rear elevational view of a first threaded button head drive bolt of a preferred embodiment of the invention.

FIG. 20 is a right side elevational view of a first step washer of a preferred embodiment of the invention.

FIG. 21 is a front elevational view of a first step washer of a preferred embodiment of the invention.

FIG. 22 is a rear elevational view of a first step washer of a preferred embodiment of the invention.

FIG. 23 is a right side elevational view of a second threaded button head drive bolt of a preferred embodiment of the invention.

FIG. 24 is a front elevational view of a second threaded button head drive bolt of a preferred embodiment of the invention.

FIG. 25 is a rear elevational view of a second threaded button head drive bolt of a preferred embodiment of the invention.

FIG. 26 is a rear elevational view of a sprocket flange of a second pedal-powered crank assembly of the preferred embodiment of the invention.

FIG. 27 is a rear elevational view of a sprocket flange of a second pedal-powered crank assembly of the preferred embodiment of the invention.

### DESCRIPTION OF THE PREFERRED EMBODIMENT

While this present invention is susceptible of embodiments in many different forms, there are shown in the drawings and will be described in detail herein, a preferred embodiment, with like parts designated by like reference numerals and with the understanding that the present disclosure is to be considered as an exemplification of the principles of the present invention, and is not intended to limit the claims to the illustrated preferred embodiment.

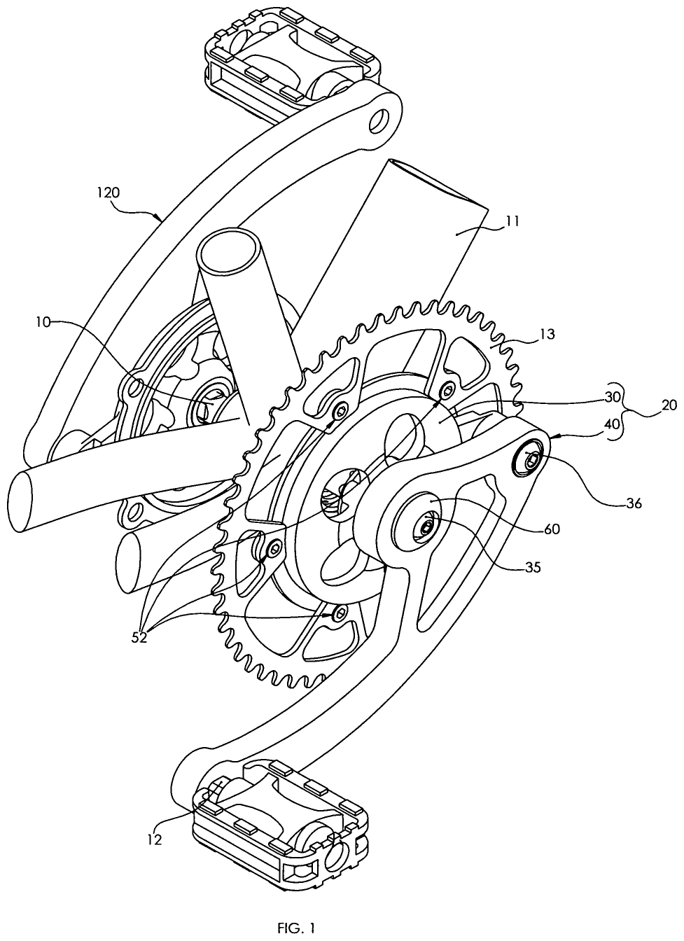

FIG. 1 illustrates, in a preferred embodiment, a conventional bicycle crank shaft 10 mounted in a conventional bicycle hub 11 and defining a generally axially threaded chamber (not shown) extending at least partially therethrough, a first conventional pedal bolt 12 having one or more threaded ends (not shown), a pedal-powered crank assembly 20 having a first sprocket flange 30 and a first pedal crank arm 40, the conventional sprocket 13 coaxially affixed to the first sprocket flange 30, and the first conventional pedal bolt 12 affixed to the first pedal crank arm 40.

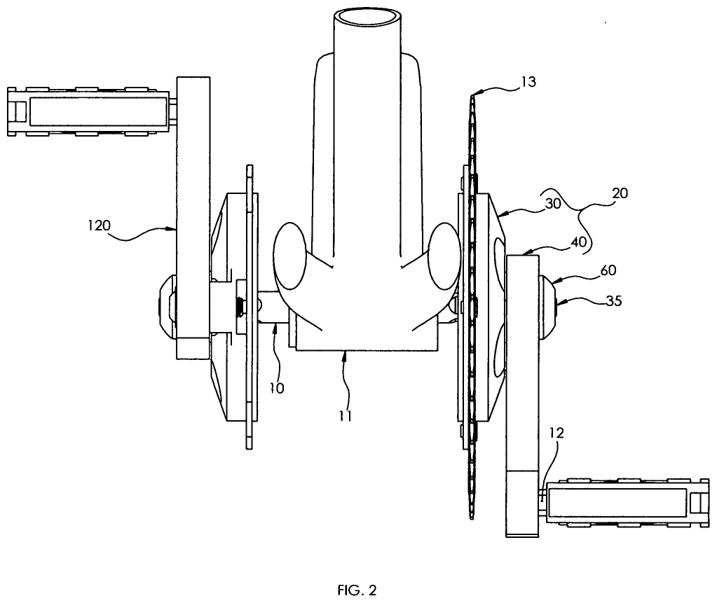

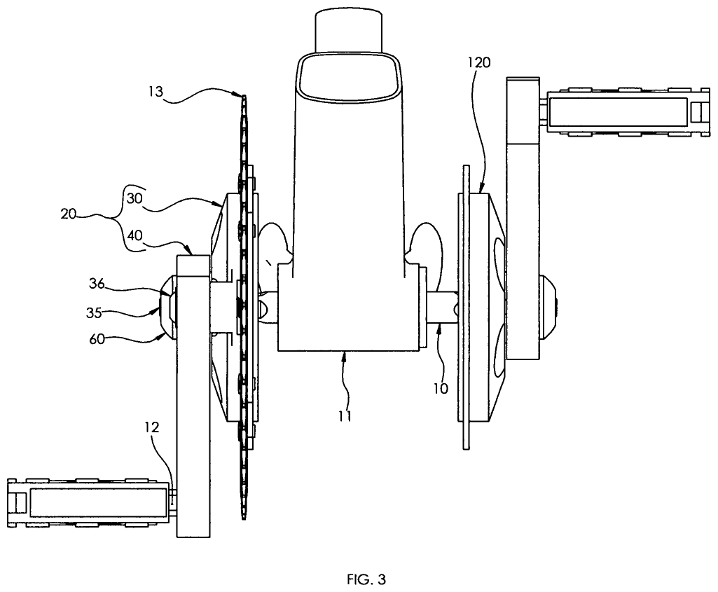

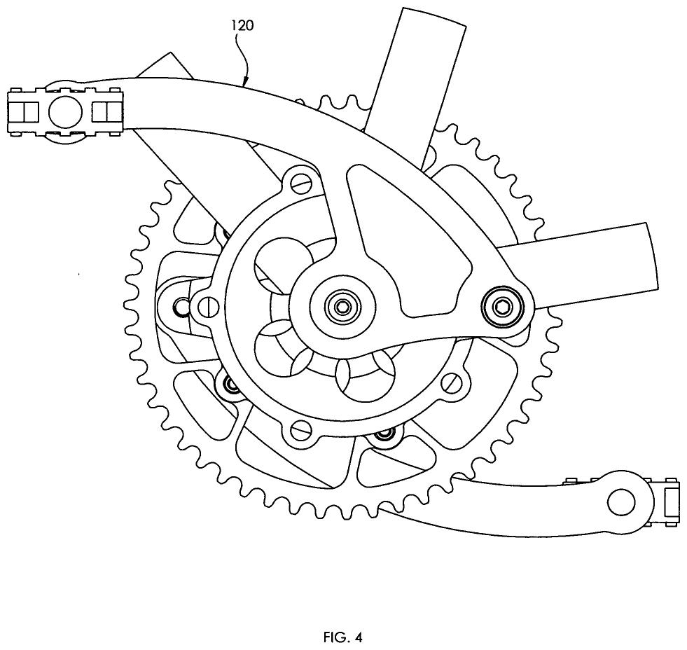

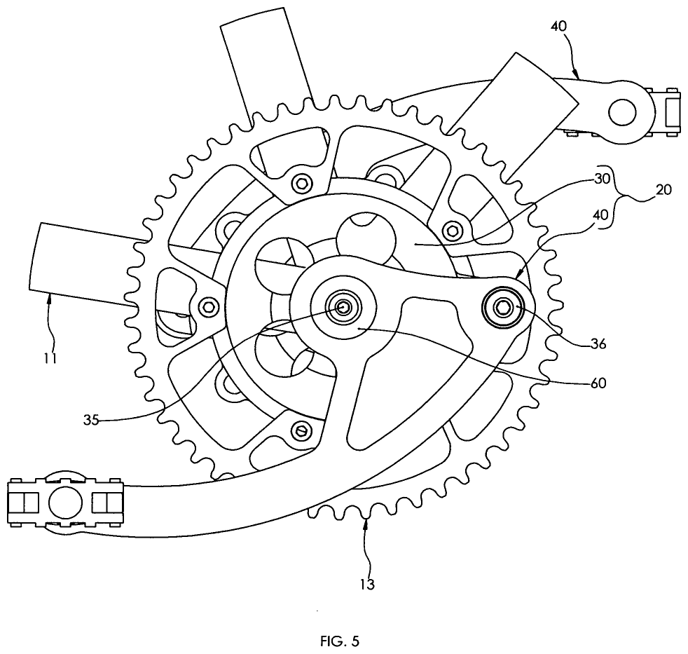

FIGS. 2-5 illustrate, in a preferred embodiment, the pedal-powered crank assembly 20.

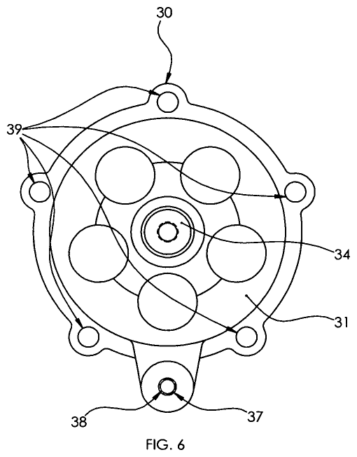

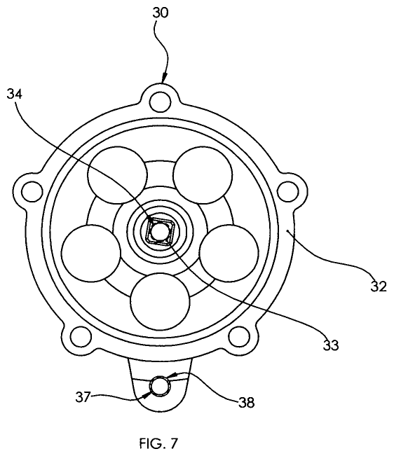

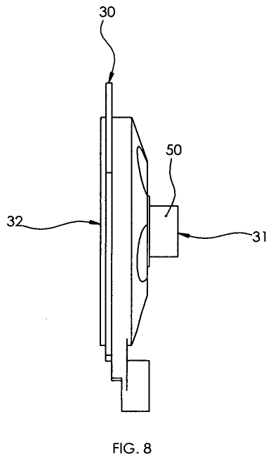

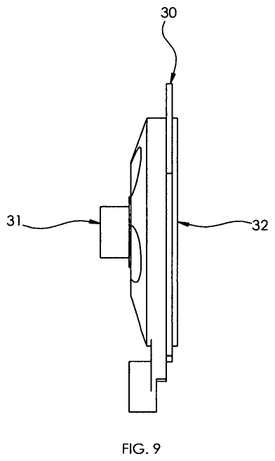

FIGS. 6-9 illustrate, in a preferred embodiment, the first sprocket flange 30. The generally disc-shaped first sprocket flange 30 has a front side 31, a back side 32, and defines a cavity 33 on the back side 32 dimensioned for cooperative engagement of and coaxial mounting the first sprocket flange 30 on the end of the conventional bicycle crank shaft 10. The first sprocket flange 30 defines a generally cylindrical opening 34 extending axially therethrough for receiving the conventional threaded bicycle crank bolt 35. The front side 31 of the first sprocket flange 30 defines a first laterally projecting generally cylindrical shaft member 50 dimensioned for cooperative engagement with the first pedal crank arm 40. The first sprocket flange 30 defines a first generally cylindrical slot 37 extending therethrough and disposed proximate the perimeter of the first sprocket flange 30 for receiving a first step washer 38 therein, as shown in in FIGS. 6 and 7, although it should also be readily understood by those skilled in the art that a threaded cylinder could be integrally constructed with the first sprocket flange 30 in place of a first generally cylindrical slot 37 and a first step washer 38. The first sprocket flange 30 defines a plurality of radially disposed generally cylindrical first apertures 39 proximate the perimeter of the first sprocket flange 30. In the preferred embodiment, the first sprocket flange 30 is constructed of an aluminum alloy, although it should also be readily understood by those skilled in the art that any suitable material of constriction should suffice. In use, the conventional sprocket 13 is coaxially affixed to the first sprocket flange 30 using a plurality of bolts 52 (shown in FIG. 1) disposed in the generally cylindrical first apertures 39 proximate the perimeter of the first sprocket flange 30, although it should be readily understood by those skilled in the art that other attachments means, such as welding may suffice. It should also be readily understood by those skilled in the art that the conventional sprocket 13 may be integrally formed with the first sprocket flange 30.

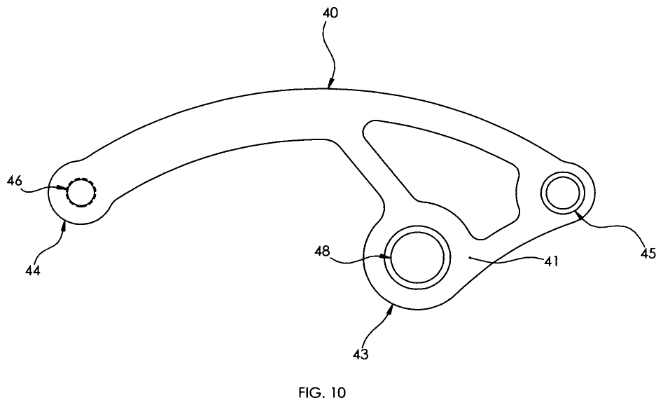

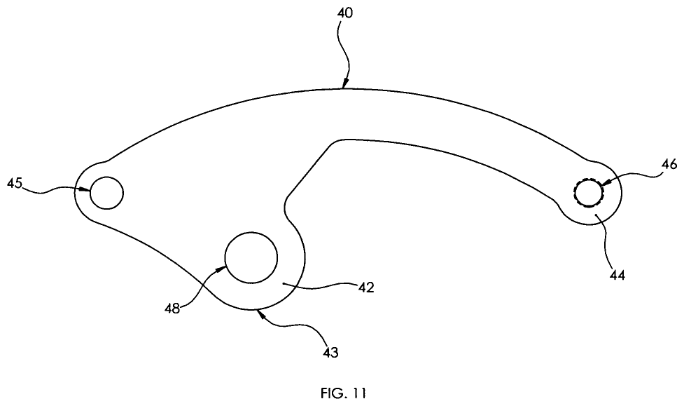

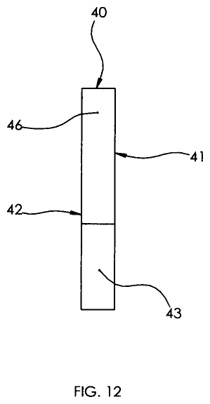

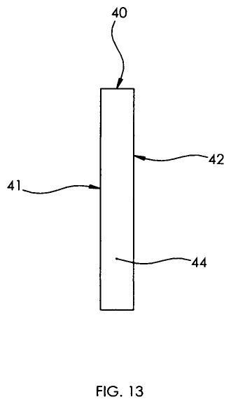

FIGS. 10-13 illustrate, in a preferred embodiment, the first pedal crank arm 40. The first pedal crank arm 40 has a front side 41, a back side 42, a first end 43, and a distal end 44. The first pedal crank arm 40 defines a first generally cylindrical hollow 48 in the first end 43 for coaxially mounting the first pedal crank arm 40 on the first laterally projecting generally cylindrical shaft member 50 of the first sprocket flange 30 and using a first conventional threaded crank bolt 35 for fastening the first sprocket flange 30 and the first pedal crank arm 40 to the threaded chamber on the end of the bicycle crank shaft 10, as shown in FIG. 1.

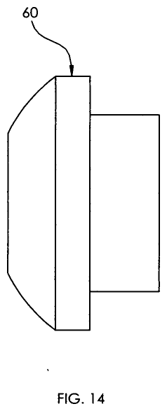

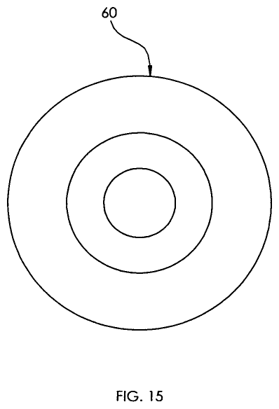

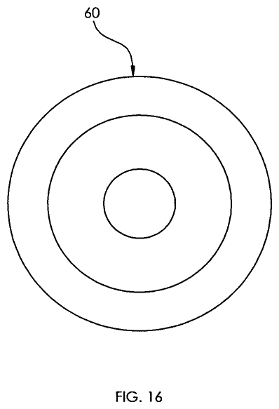

The first generally cylindrical hollow 48 of the first pedal crank arm 40 is preferably dimensioned to receive a second step washer 60, as illustrated in FIGS. 1 and 14-16.

The first pedal crank arm 40 defines a second generally cylindrical hollow 45 extending therethrough. The second generally cylindrical hollow 44 and the first generally cylindrical slot 37 are aligned and a second threaded bolt 36 is received through the second generally cylindrical hollow 45 and threaded into the first step washer 38 to fasten the first pedal crank arm 40 to the first sprocket flange 30.

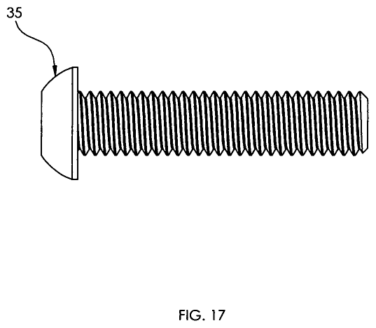

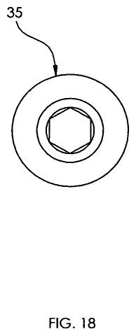

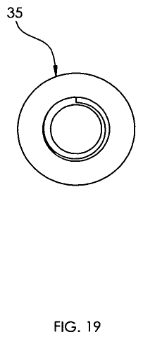

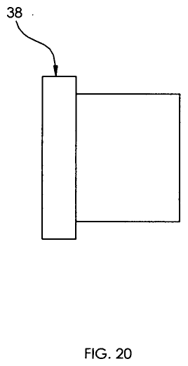

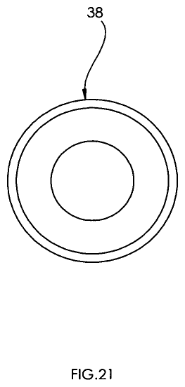

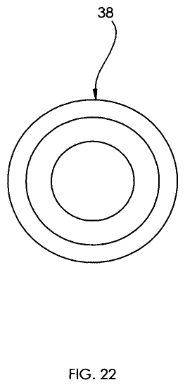

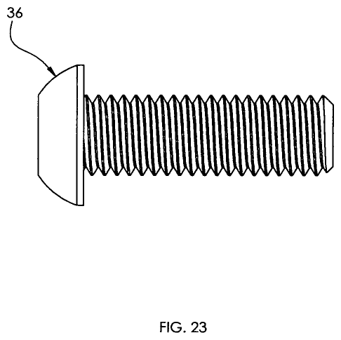

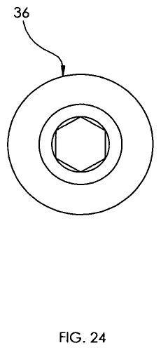

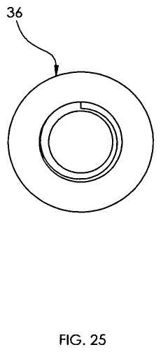

The second threaded bolt 36 is preferably a threaded button head drive bolt, as illustrated in FIGS. 17-19.

The first pedal crank arm 40 defines a third generally cylindrical hollow 46 which is disposed proximate a distal end 44 of the first pedal crank arm 40, generally opposite the second threaded bolt 36 with a 145 degree offset about the axis of rotation of the bicycle crank shaft 10 to optimize the leverage and power imparted to the pedal-powered crank assembly 20. In the preferred embodiment, the first pedal crank arm 40 is generally concave-shaped from the distal end 44 to the second generally cylindrical hollow 45, although it should also be readily understood by those skilled in the art that other shapes may suffice. In the preferred embodiment, the first pedal crank arm 40 is constructed of an aluminum alloy, although it should also be readily understood by those skilled in the art that any suitable material of constriction should suffice.

In the preferred embodiment, a second pedal-powered crank assembly 120 constructed according to the principles of the first pedal-powered crank assembly 20 is coaxially affixed to the opposite end of the bicycle crank shaft 10, with the first pedal-powered crank assembly 20 and second pedal-powered crank assembly 120 disposed 180 degrees opposed to each other to provide continuous, uninterrupted torque to the bicycle crank shaft 10 through a 360-degree rotation of the first bicycle crank assembly 20 and second pedal-powered crank assembly 120. It should be readily understood by those skilled in the art that a second conventional pedal bolt should be employed, but a second conventional sprocket is not necessary.

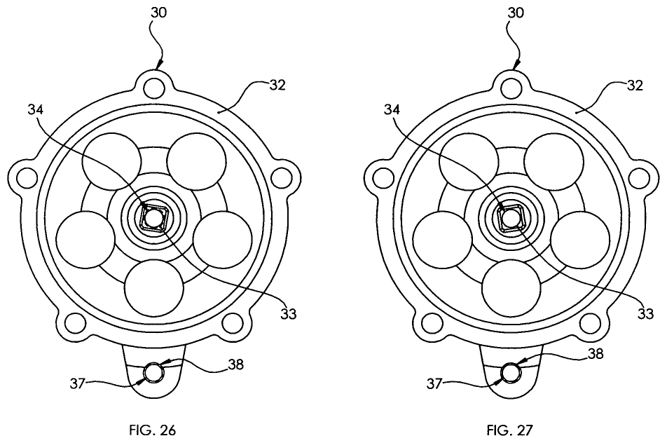

FIGS. 26-27 illustrate, in a preferred embodiment, the sprocket flange 30 of the first pedal-powered crank assembly 20 and the sprocket flange of the second pedal-powered crank assembly 120 of the preferred embodiment of the invention, showing the cavity 33 on the back side 32 of each sprocket flange 30 dimensioned and disposed for cooperative engagement of and coaxial mounting on the end of the conventional bicycle crank shaft 10 in offset fashion.

Hence, while the invention has been described in connection with a preferred embodiment and alternative embodiments, it will be understood that it is not intended that the invention be limited to those embodiments. On the contrary, it is intended to cover all alternatives, modifications and equivalents as may be included within the spirit and scope of the invention as disclosed.

As to the manner of usage and operation of the instant invention, same should be apparent from the above disclosure, and accordingly no further discussion relevant to the manner of usage and operation of the instant invention shall be provided.

With respect to the above description then, it is to be realized that the optimum proportions for the elements of the invention, and variations in size, materials, shape, form, function and manner of operation, assembly and use, are deemed readily apparent and obvious to one skilled in the art, and all equivalent relationships described in the specification are intended to be encompassed by the present invention.

Therefore, the foregoing is considered illustrative of only the principles of the invention. Further, since numerous modifications and changes will readily occur to those skilled in the art, it is not desired to limit the invention to the exact method, construction and operation shown and described, and accordingly, all suitable modifications and equivalents may be resorted to, falling within the scope of the invention.

What is claimed is:

1. A first pedal-powered crank assembly, particularly suited for use in combination with a bicycle crank shaft, said pedal-powered crank assembly comprising:
a first sprocket flange having a first sprocket flange front side and a first sprocket flange back side;
means for coaxially affixing said first sprocket flange to the first end of a crank shaft;
a first pedal crank arm having a first pedal crank arm first end and a first pedal crank arm distal end;
means for coaxially affixing said first pedal crank arm first end about said first sprocket flange;
a first pedal bolt;
means for affixing said first pedal bolt proximate said first pedal crank arm distal end of said first pedal crank arm; and
means for affixing said first pedal crank arm proximate the perimeter of said first sprocket flange generally opposite said first pedal bolt with an offset about the axis of rotation of the bicycle crank shaft.

2. The first pedal-powered crank assembly of claim 1, wherein the offset measures approximately 145 degrees.

3. The first pedal-powered crank assembly of claim 1, further comprising a sprocket and means for coaxially affixing said sprocket to said first sprocket flange.

4. The first pedal-powered crank assembly of claim 1, wherein said means for coaxially affixing said first sprocket flange to the first end of a crank shaft comprises said first sprocket flange defining a cavity on said back side dimensioned for cooperative engagement of and coaxial mounting on the end of the crank shaft.

5. The first pedal-powered crank assembly of claim 1, wherein said means for coaxially affixing said first end of said first pedal crank arm about said first sprocket flange comprises said front side of said first sprocket flange defining a first laterally projecting generally cylindrical shaft member dimensioned for cooperative engagement with said first pedal crank arm.

6. The first pedal-powered crank assembly of claim 1, wherein said first pedal crank arm is generally concave-shaped.

7. A bicycle comprising the first pedal-powered crank assembly of claim 1 further comprising a second pedal-powered crank assembly constructed according to the principles of the first pedal-powered crank assembly coaxially affixed to the opposite end of the bicycle crank shaft, with the first pedal-powered crank assembly and second pedal-powered crank assembly 180 degrees opposed to each other to provide continuous, uninterrupted torque to the bicycle crank shaft through a 360-degree rotation of the first bicycle crank assembly and second pedal-powered crank assembly.

8. The first pedal-powered crank assembly of claim 7, wherein the offset measures approximately 145 degrees.
